(19) United States
(12) Patent Application Publication
(10) Pub. No.: US 2017/0149071 A1
(43) Pub. Date: May 25, 2017

(54) BIPOLAR PLATE FOR A FUEL CELL AND FUEL CELL STACK INCLUDING A FUEL CELL

(71) Applicant: Volkswagen AG, Wolfsburg (DE)

(72) Inventors: Brian Dickson, Burnaby (CA); Andrew Desouza, Burnaby (CA)

(21) Appl. No.: 15/360,663

(22) Filed: Nov. 23, 2016

(30) Foreign Application Priority Data
Nov. 24, 2015 (DE) DE102015223169.0
Dec. 15, 2015 (DE) DE102015225228.0

(51) Int. Cl. H01M 8/0234; H01M 8/0258; H01M 8/0267

(52) U.S. Cl. CPC H01M 8/0234; H01M 8/0267; H01M 8/0258; H01M 2250/20

(57) ABSTRACT

A bipolar plate for a fuel cell includes an anode side and a cathode side, wherein in a top view onto the anode side or cathode side:
operating medium flow fields include an anode gas flow field situated on the anode side, a cathode gas flow field situated on the cathode side, and an internal coolant flow field,
a first supply area and a second supply area situated on diametrically opposite sections of the bipolar plate lateral to the operating medium flow fields,
supply ports situated in the first and second supply areas as through openings, an anode gas port for supplying or removing the anode gas, a cathode gas port for supplying or removing the cathode gas, and a coolant port for supplying or removing the coolant, the anode gas port being situated within a supply area between the cathode gas port and the coolant port, and the bipolar plate including or being made of a carbon-based electrically conductive material.

This claims the benefit of German Patent Applications DE 10 2015 223 169.0, filed Nov. 24, 2015 and DE 10 2015 225 228.0, filed Dec. 15, 2015, both of which are hereby incorporated by reference herein.

The present invention relates to a bipolar plate for a fuel cell or a fuel cell stack. The present invention further relates to a fuel cell or a fuel cell stack including such a bipolar plate. In addition, the present invention relates to a vehicle or a fuel cell system including such a fuel cell or such a fuel cell stack.

### BACKGROUND

Fuel cells use the chemical reaction of a fuel with oxygen to form water in order to generate electrical energy. For this purpose, fuel cells contain as a core component the so-called membrane electrode assembly (MEA), which is a structure made up of an ion-conducting (mostly proton-conducting) membrane and a catalytic electrode (anode and cathode) situated on both sides of the membrane. The latter include mostly supported noble metals, in particular, platinum. In addition, gas diffusion layers (GDL) may be situated on both sides of the electrodes of the membrane electrode assembly facing away from the membrane. In general, the fuel cell is formed by a plurality of stacked MEAs, whose electrical powers add up. In general, bipolar plates (also known as flow field plates or separator plates), which ensure supply of the single cells with the operating media, i.e., the reactants, are situated between the individual membrane electrode assemblies, and are normally also used for cooling. In addition, the bipolar plates provide an electrically conductive contact to the membrane electrode assemblies.

During operation of the fuel cell, the fuel (anode gas, anode operating medium), in particular, hydrogen H₂ or a hydrogen-containing gas mixture, is fed to the bipolar plate of the anode through an open flow field on the anode side, where an electrochemical oxidation of H₂ to protons H⁺ takes place with release of electrons (H₂=>2H⁺+2e⁻). Water-bound or water-free transport of protons from the anode chamber into the cathode chamber takes place via the electrolytes or the membrane, which gas-tightly separate and electrically insulate the reaction chambers from each other. The electrons provided on the anode are conducted to the cathode via an external electrical circuit containing an electrical consumer or an energy store. Oxygen or an oxygen-containing gas mixture (for example, air) is fed to the cathode as cathode operating medium (cathode gas) via an open flow field of the bipolar plate on the cathode side, so that a reduction from O₂ to O²⁻ takes place with the reception of electrons (½O₂+2e⁻=>O²⁻). At the same time, in the cathode chamber, the oxygen anions react with the protons transported through the membrane with the formation of water (O²⁻+2H⁺=>H₂O).

Bipolar plates are known in different versions. The basic purposes in designing bipolar plates are weight reduction, overall space reduction, cost reduction, and increase in power density. These criteria are important in particular for mobile applications of fuel cells, for example, for electromotive traction of vehicles.

Bipolar plates are made of an electrically conductive material, since they are used for the actual electrical connection of the single cells to each other and to the outside. They are usually manufactured of a metallic material such as steel and the like. However, bipolar plates made of an electrically conductive carbon-based material, in particular, graphite and graphite composite materials are also known. Carbon-based materials (henceforth also referred to as carbon materials) have certain advantageous properties, in particular, low density, which is why they are of special interest for mobile applications. It is, however, disadvantageous that, for mechanical reasons, carbon materials require a greater wall thickness than metallic bipolar plates, which in turn counteracts the purpose of overall space reduction. The wall thickness of carbon bipolar plates is typically in the range of 0.2 mm to 0.25 mm, against only 0.1 mm for metallic bipolar plates. Due to their greater wall thickness, carbon bipolar plates used so far basically have different designs from that of metallic bipolar plates.

Metallic bipolar plates are often manufactured of two profiled half-plates welded together (the so-called anode plate and cathode plate), in which the required flow fields for the operating media (anode gas, cathode gas and coolant) are formed by a suitable profile in both half-plates. There is an anode flow field on the anode side and a cathode flow field on the cathode side, while the coolant flow field is formed inside between the two plates. Outside the flow fields, the bipolar plate has supply ports designed as through openings, at least two anode gas ports for supply and removal of the anode gas, at least two cathode gas ports for supply and removal of the cathode gas, and at least two coolant ports for supply and removal of the coolant being provided. In the stacked state, these supply ports align with each other and form operating medium main channels, which go through the entire length of the fuel cell stack. From the supply ports of the bipolar plate, anode, cathode, and coolant distribution channels distribute the operating media to the entire width of the bipolar plate to feed them to the catalytic electrodes (anode and cathode). It is a problem that in this distribution area, the different channels intersect on a relatively small surface. This results in an increase in the total thickness of the bipolar plate and thus of the total required installation space of the fuel cell stack.

Examples of a bipolar plate according to the above description are described in US 2006/0127706 A1 and DE 102007 008 214 A1. In those documents, the supply ports are situated on the two diametrically opposite narrow sides of the bipolar plates, the coolant port being positioned essentially between the anode gas port and the cathode gas port. Another embodiment of a metallic bipolar plate is described in DE 10 2013 210 542 A1. In order to equalize the lengths of the anode gas distribution channels, the anode gas port is situated here between the cathode gas port and the coolant port.

Present-day carbon bipolar plates have an overall plate thickness, i.e., thickness between the lowest and the highest point, of approximately 1.5 mm. Thinner carbon bipolar plates are so far not known.

### SUMMARY OF THE INVENTION

It is an object of the present invention to provide a carbon bipolar plate that has a smaller overall height (total plate thickness) than known carbon bipolar plates. The bipolar plate is thus to make fuel cell stacks possible that, with the same power density, have a smaller overall height (stack height) than known fuel cell stacks based on carbon bipolar plates.

The bipolar plate according to the present invention for a fuel cell includes an anode side and a cathode side, the bipolar plate having the following in a top view on the anode side or cathode side:
operating medium flow fields including an anode gas flow field situated on the anode side, a cathode gas flow field situated on the cathode side, and an inner coolant flow field,
a first supply area and a second supply area, which are situated on diametrically opposite sections of the bipolar plate lateral to the operating media flow fields,
supply ports situated in the supply areas and designed as through openings, at least one anode gas port being situated in each of the first and second supply areas for feeding and removing the anode gas, at least one cathode gas port for feeding and removing the cathode gas, and at least one coolant port for feeding and removing the coolant, an anode gas port being situated within a supply area between a cathode gas port and a coolant port, and
the bipolar plate including or being made of a carbon-based electrically conductive material.

In conventional carbon-based bipolar plates, the supply ports are usually situated in such a way that the coolant port is between the anode gas port and the cathode gas port. By situating the anode gas port between the cathode gas port and the coolant port, it is advantageously achieved that the distribution areas, in which the operating media are distributed on the width of the active area of the bipolar plate or collected by the latter, may be designed to have a smaller total thickness than in the case of central positioning of the coolant port. In particular, the distribution areas may be designed in such a way that the coolant distribution channels run from the coolant port initially on the cathode side without intersecting the cathode distribution channels and then pass to the anode side. This allows the overall height of the bipolar plate to be reduced.

The bipolar plate preferably has a total plate thickness (overall height measured from the lowest to the highest point of the bipolar plate) of maximum 1.2 mm, in particular, maximum 1.1 mm, preferably maximum 1.0 mm. The smaller the overall height of the bipolar plate, the smaller also the overall height of a fuel cell stack having such a bipolar plate. Of course, the lower limit of the overall height is limited by the functional and stability requirements for the bipolar plate. Overall heights smaller than 0.8 mm for carbon-based bipolar plates result in unacceptably small flow cross-sections for the operating media and/or in insufficient stability. A wall thickness of the bipolar plate, in particular of its half-plates, is preferably in the range of 0.2 mm to 0.25 mm.

In a preferred embodiment of the present invention, the carbon-based electrically conductive material is a graphite material, in particular, graphite or a graphite-plastic composite. For example, a composite material of graphite and epoxy polymer may be used. These materials are characterized by good electrical conductivity and low density. Henceforth, carbon-based electrically conductive materials are also referred to as carbon materials or carbon.

In another preferred embodiment of the present invention, the bipolar plate is formed from two profiled half-plates joined to each other, namely one anode plate and one cathode plate, in which the corresponding operating medium flow fields are preferably designed in the form of channel profiles. Manufacturing from two profiled half-plates has the advantage that the coolant flow field may be produced between the two half-plates in a simple manner. The half-plates may be manufactured from carbon sheets of uniform thickness, for example, using manufacturing methods such as stamping, deep-drawing, and punching, and subsequently integrally joined to each other.

In some embodiments of the present invention, the operating medium flow fields have a central active section and two distribution sections adjacent thereto on both sides, which are situated between the active section and the supply ports and contain anode gas distribution channels, cathode gas distribution channels, and coolant distribution channels. The distribution sections and distribution channels are responsible for distributing the operating media from the feeding supply ports to the entire width of the active flow field and for gathering the operating media flowing from the active flow field and conducting them to the corresponding discharging supply ports.

The distribution sections preferably have an essentially triangular shape in top view onto the anode side or cathode side of the bipolar plate. This makes it advantageously possible to situate the (comparatively small) anode gas port together with the cathode gas port or the coolant port next to one side of the triangular distribution section, and the remaining port (i.e., the coolant port or the cathode port) on the other free side of the distribution section. In either case, the largest ports (coolant port and cathode gas port) are situated on different sides.

Within the framework of the present invention, the term “active area” is understood as the area of the bipolar plate that, in the assembled fuel cell stack, faces the catalytic electrodes of the membrane electrode assembly, i.e., the area in which a chemical reaction takes place during operation of the fuel cell. In contrast, “inactive area” refers to an area, where no chemical reaction takes place. The “inactive area” includes the supply areas, including the supply ports and edge areas of the bipolar plate. In general, the inactive area also includes the distribution sections of the operating medium flow fields. Of course, the bipolar plate as such is not chemically active, strictly speaking, in any of the areas.

Only the anode gas distribution channels and the coolant distribution channels preferably run in a first section of the distribution sections. The coolant distribution channels are formed by a channel profile on the cathode side, in particular, of the cathode plate, and the anode gas distribution channels by a channel profile on the anode side, in particular, on the anode plate. This system makes a small overall height in the first section of the distribution section possible. The overall height of the bipolar plate in this first section essentially results from the sum of the channel height (profile height) of the anode plate and the channel height (profile height) of the cathode plate. Since no cathode gas distribution channels run in this first section, they also do not take up any height. It is to be noted here that the volume flow rate of the cathode operating gas is usually substantially higher than that of the anode operating gas, which has the lowest volume flow rate of the three operating media.

It is furthermore preferred that the anode gas distribution channels and the coolant distribution channels run crossing each other in the first section of the distribution sections.

In a preferred embodiment, the anode gas distribution channels, the cathode gas distribution channels, and the coolant distribution channels run in a second section of the distribution sections. The coolant distribution channels and the anode gas distribution channels are formed by a channel profile on the anode side, in particular, on the anode plate, and the cathode distribution channels by a channel profile of the cathode side, in particular, of the cathode plate. This means that the coolant distribution channels in the first section of the distribution sections run on the (otherwise unused) cathode side in order to go over to the anode side upon passing to the second section. This is advantageous, since in the second section the main volumes of the operating media, i.e., of the coolant and the cathode gas, are conducted on different sides of the bipolar plate. This makes wider distribution channels and a small overall height possible in the second section.

It is furthermore preferred that in the second section of the distribution sections, the anode gas distribution channels and the coolant distribution channels run in parallel to each other and/or the anode gas distribution channels and the coolant distribution channels run crossing the cathode gas distribution channels. Due to the parallel arrangement of the anode gas distribution channels and the coolant distribution channels in the second section, it is made possible, in particular, that the coolant distribution channels are formed by the rear profile of the anode gas distribution channels, i.e., that the two channels run nested into each other. This arrangement makes a space-saving configuration possible in particular, since only the profile height of the anode plate must be ensured for both of these operating media. The overall height of the bipolar plate in the second section essentially results from the sum of the channel height (profile height) of the anode plate and the channel height (profile height) of the cathode plate.

All in all, it is achieved by the above embodiments of the distribution section that its overall height over its entire surface results from the sum of the profile heights of the anode plate and the cathode plate. Even in the second section, in which all three operating media are conducted, no additional profile height is required. Preferably, the overall height of the second section of the distribution area corresponds to the overall height of the first section of the distribution area, i.e., the latter has an essentially constant overall plate thickness over its entire surface, which again preferably also corresponds to the overall height of the active area.

Another aspect of the present invention relates to a fuel cell stack, which includes membrane electrode assemblies, and bipolar plates according to the present invention, which are stacked alternatingly with each other.

According to one preferred embodiment, the fuel cell stack further includes a gas diffusion layer situated between the membrane electrode assemblies and the bipolar plates, which extends over the entire anode gas flow field, the entire cathode gas flow field, and the entire coolant flow field, i.e., over the active area and the distribution areas. The gas diffusion layer preferably extends exclusively over the aforementioned operating media flow fields and thus essentially does not protrude into the supply areas. Gas diffusion layers are known and are made of an electrically conductive gas-permeable material. They are used for the uniform distribution of the gaseous operating media fed via the bipolar plates to the catalytic electrodes. Normally the gas diffusion layers extend only across the active area and not across the distribution areas of the flow fields. Since, in this embodiment, the gas diffusion layers also extend across the distribution areas, mechanical stabilization not only of the membrane, but also of the bipolar plates in the distribution areas is achieved. This is of importance in particular due to the manufacture of the bipolar plate of a carbon material and the inherent fragility of the distribution areas with their channels situated therein in the narrowest space. Since the gas diffusion layers cover all operating media flow fields, stresses caused by pressure differences between the operating media (cathode gas, anode gas, and coolant) are also counteracted. The gas diffusion layer may be designed as a separate component or as part of the membrane electrode assembly.

Another aspect of the present invention relates to a fuel cell system, which includes such a fuel cell stack. In particular, the fuel cell system includes, in addition to the fuel cell stack, an anode supply and a cathode supply including the appropriate peripheral components.

Another aspect of the present invention relates to a vehicle, which includes a fuel cell system including a fuel cell stack according to the present invention. The vehicle is preferably an electric vehicle, in which electrical energy generated by the fuel cell system is used for supplying an electric traction motor and/or a traction battery.

The different specific embodiments of the present invention described in this application may be combined with each other, unless otherwise specified in the individual case.

### BRIEF DESCRIPTION OF THE DRAWINGS

The present invention is elucidated below with the aid of exemplary embodiments illustrated in the drawings.

FIG. 1 shows a block diagram of a fuel cell system according to a preferred embodiment;

FIG. 2 shows a top view onto a membrane electrode assembly according to the present invention;

FIG. 3 shows a top view onto a bipolar plate according to the present invention;

FIG. 4 shows a detailed view of the bipolar plate of FIG. 3, and

FIG. 5 shows a detailed view of FIG. 4 including flow patterns of the operating media.

### DETAILED DESCRIPTION

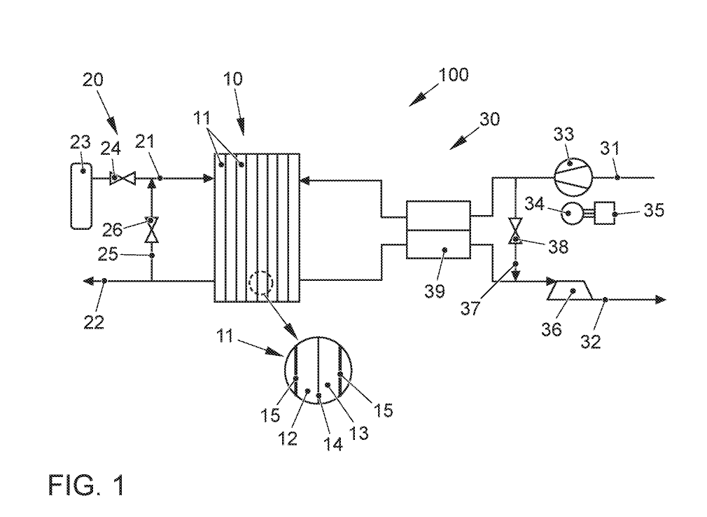

FIG. 1 shows a fuel cell system on the whole identified with reference numeral 100 according to a preferred embodiment of the present invention. Fuel cell system 100 is part of a not further illustrated vehicle, in particular, of an electric vehicle, which includes an electric motor, which is supplied with electrical energy by fuel cell system 100.

Fuel cell system 100 includes as a core component a fuel cell stack 10, which includes a plurality of single cells 11 arranged in the form of a stack, the single cells being formed by alternatingly stacked membrane electrode assemblies (MEA) 14 and bipolar plates 15 (see detailed view). Each single cell 11 thus includes a MEA 14, which includes an ion-conductive polymer-electrolyte membrane and catalytic electrodes situated on both sides thereof, namely an anode and a cathode, which catalyze the corresponding fuel cell conversion partial reaction and, in particular, may be designed as coatings on the membrane. The anode electrode and the cathode electrode include a catalytic material, for example, platinum, which is here supported by an electrically conductive support material of large specific surface, for example, a carbon-based material. An anode chamber 12 is thus formed between a bipolar plate 15 and the anode, and a cathode chamber 13 between the cathode and the next bipolar plate 15. Bipolar plates 15 are used for feeding the operating media into anode chamber 12 and cathode chamber 13 and also establish the electrical connection between the individual fuel cells 11. Optionally, gas diffusion layers may be situated between membrane electrode assemblies 14 and bipolar plates 15.

In order to supply fuel cell stack 10 with operating media, fuel cell system 100 includes, on the one hand, an anode supply 20 and, on the other hand, a cathode supply 30. A cooling circuit also present is not illustrated in FIG. 1.

Anode supply 20 includes an anode supply path 21, which is used for feeding an anode operating medium (the fuel), for example, hydrogen, into anode chambers 12 of fuel cell stack 10. For this purpose, anode supply path 21 connects a fuel storage device 23 to an anode inlet of fuel cell stack 10. Anode supply 20 further includes an anode exhaust gas path 22, which removes the anode exhaust gas from anode chambers 12 via an anode outlet of fuel cell stack 10. The anode operating pressure in anode chambers 12 of fuel cell stack 10 is adjustable via adjusting means 24 in anode supply path 21. In addition, anode supply 20 may include, as illustrated, a fuel recirculation line 25, which connects anode exhaust gas path 22 to anode supply path 21. Fuel is usually recirculated in order to feed back and use the mostly stoichiometrically used fuel to the stack. Another adjusting means 26, using which the recirculation rate may be adjusted, may optionally be situated in fuel recirculation line 25.

Cathode supply 30 includes a cathode supply path 31, which feeds an oxygen-containing cathode operating medium, in particular, air aspirated from the surroundings, to cathode chambers 13 of fuel cell stack 10. Cathode supply 30 further includes a cathode exhaust gas path 32, which removes the cathode exhaust gas (in particular, exhaust air) from cathode chambers 13 of fuel cell stack 10 and optionally feeds it to an exhaust system (not illustrated). A compressor 33 is situated in cathode supply path 31 for pumping and compressing the cathode operating medium. In the specific embodiment illustrated, compressor 33 is designed as a mainly electromotively driven compressor whose drive takes place via an electric motor 34 equipped with appropriate power electronics 35. As a support, compressor 33 may also be driven by a turbine 36 (optionally with a variable turbine geometry) situated in cathode exhaust gas path 32, via a shared shaft (not illustrated).

According to the exemplary embodiment illustrated, cathode supply 30 may also include a wastegate line 37, which connects cathode supply line 31 to cathode exhaust gas line 32, i.e., represents a bypass of fuel cell stack 10.

Wastegate line 37 allows the excess air mass flow to bypass fuel cell stack 10 without slowing down compressor 33. An adjusting means 38 situated in wastegate line 37 is used to control the quantity of cathode operating medium bypassing fuel cell stack 10. All adjusting means 24, 26, 38 of fuel cell system 100 may be designed as adjustable or non-adjustable valves or dampers. Other similar adjusting means may be situated in lines 21, 22, 31, and 32 to allow fuel cell stack 10 to be isolated from the surroundings.

Fuel cell system 100 may furthermore include a humidifier 39, which typically includes a plurality of water vapor-permeable membranes, which are either flat or are designed in the form of hollow fibers. Humidifier 39 is situated in cathode supply path 31 in such a way that, on the one hand, the comparatively dry cathode operating gas flows over one side of the membranes and, on the other hand, is situated in cathode exhaust gas path 32 in such a way that the comparatively moist cathode exhaust gas flows over their other side. Driven by the higher water vapor partial pressure in the cathode exhaust gas, the water vapor passes over the membrane into the cathode operating gas, which is thus moistened.

Various further details of anode supply 20 and cathode supply 30 are not shown in the simplified FIG. 1 for the sake of clarity. Thus, for example, a water separator may be installed in anode exhaust gas path 22 and/or cathode exhaust gas path 32 to condense and discharge the product water produced by the fuel cell reaction. Finally, anode exhaust gas line 22 may open into cathode exhaust gas line 32, so that the anode exhaust gas and the cathode exhaust gas are removed over a shared exhaust system.

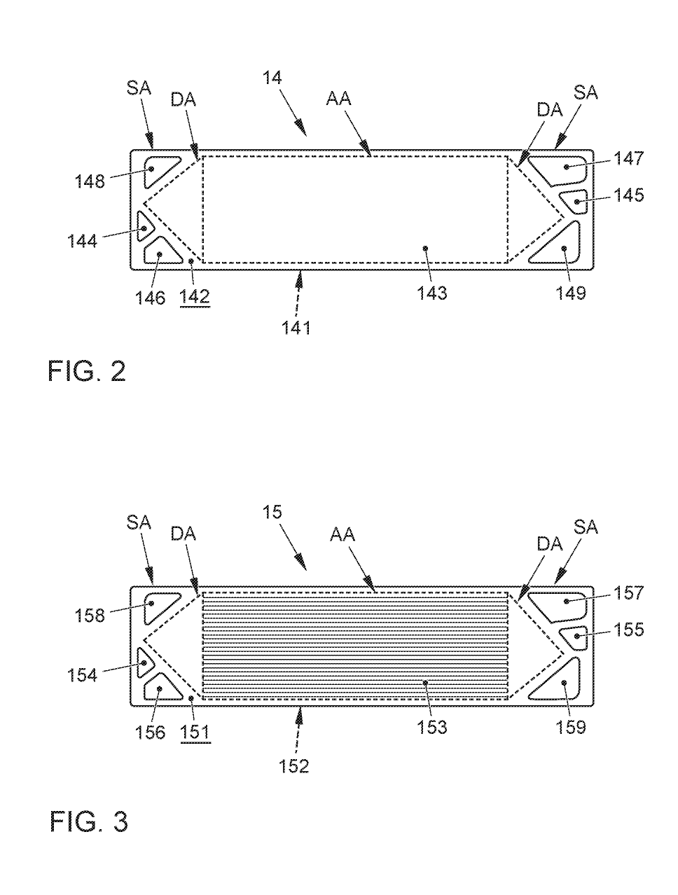

FIGS. 2 and 3 show an exemplary membrane electrode assembly 14 and bipolar plate 15 according to the present invention in a top view.

Both components 14, 15 have an active area AA, which is surrounded by a rectangular-contour dashed line for clarity. Active area AA is characterized in that the fuel cell reactions take place in this area. For this purpose, active area AA of membrane electrode assembly 14 has a catalytic electrode 143 on both sides of the polymer electrolyte membrane. The remaining inactive areas of components 14, 15 have two supply areas SA and two distribution areas DA. Supply points 144 through 149 are situated within supply areas SA on the membrane electrode assembly 14 side and supply points 154 through 159 are situated on the bipolar plate 15 side, which are essentially aligned with each other in the stacked state, forming main supply channels within fuel cell stack 10. Anode inlet ports 144 and 154 are used for feeding the anode operating gas, i.e., the fuel, for example, hydrogen. Anode outlet ports 145 and 155 are used for removing the anode exhaust gas after it has flowed across active area AA. Cathode inlet ports 146 and 156 are used for feeding the cathode operating gas, which is oxygen or an oxygen-containing mixture, preferably air. Cathode outlet ports 147 and 157 are used for removing the cathode exhaust gas after it has flowed across active area AA. Coolant inlet ports 148 and 158 are used for feeding the coolant, and coolant outlet ports 149 and 159, for removing the coolant. According to the present invention, anode gas ports 154, 155 of bipolar plate 15 are essentially situated between one of cathode gas ports 156, 157 and one of coolant ports 158, 159, i.e., cathode gas ports 156, 157 and coolant ports 158, 159 are essentially situated in the corner areas of bipolar plate 15. In the same way, anode gas ports 144, 145 of MEA 14 are essentially situated between one of cathode gas ports 146, 147 and one of coolant ports 148, 149. Anode gas ports 144, 145, 154, 155 have the smallest clear cross-section area of all supply ports, since, according to the normal mode of operation of fuel cells, the anode operating gas is fed at the smallest volume flow rate.

MEA 14 has a cathode side 142, which is apparent in FIG. 2. Catalytic electrode 143 shown is thus designed as a cathode, for example, as a coating on the polymer electrolyte membrane. Anode side 141, not visible in FIG. 2, has a similar catalytic electrode, here the anode. The polymer electrolyte membrane may extend over the entire width of membrane electrode assembly 14, but at least over active area AA. In the remaining areas, a reinforcing support foil may be situated, which encloses the membrane.

Not shown in FIG. 2 are gas diffusion layers, which are situated on both sides of membrane electrode assembly 14 and extend over both active area AA and the two distribution areas DA. According to the example of FIG. 2, the gas diffusion layers thus have a hexagonal shape and extend exclusively over active area AA and distribution areas DA, i.e., they do not protrude into supply areas SA. The gas diffusion layers are made of an electrically conductive gas-permeable material, for example, of a carbon-based material, and are used for uniformly distributing the operating media, fed via bipolar plate 15, to catalytic electrodes 143. The gas diffusion layer may be designed as a separate component or is (here preferably) designed as part of membrane electrode assembly 14, in that it is held together by the membrane and the catalytic electrodes, for example, with a slight overlap by the support foil. A layer sequence of such a membrane electrode assembly 14 in active area AA and also in distribution area DA thus corresponds to gas diffusion layer/electrode (anode)/membrane/electrode (cathode)/gas diffusion layer. The gas diffusion layers result in mechanical support of the membrane, but also of the fragile distribution areas DA of bipolar plate 15.

Bipolar plate 15 illustrated in FIG. 3 has two joined plate halves, anode plate 151 and cathode plate 152, concealed in the illustration. Both plate halves 151, 152 are made of an electrically conductive material (carbon material). Plates 151, 152 are integrally joined together, for example, with the aid of a circumferential weld seam or the like. Bipolar plate 15 may also include a seal (not shown) on both half-plates 151, 152, which is designed, for example, in the form of a sealing bead surrounding the entire bipolar plate 15. In addition, individual supply ports 154 through 159 may also be each surrounded by a seal.

An operating medium flow field 153 (anode flow field) is formed on anode plate 151 illustrated, which is typically present in the form of a system of open groove-like channels connecting anode inlet port 154 to anode outlet port 155. In the same way, cathode plate 152 (not visible here) has a similar cathode flow field including channels, which connect cathode inlet port 156 to cathode outlet port 157. These operating medium channels for the anode operating medium are also designed as open groove-like channels. Enclosed coolant channels connecting coolant inlet port 158 to coolant outlet port 159 run inside bipolar plate 15, in particular, between the two plate halves 151, 152.

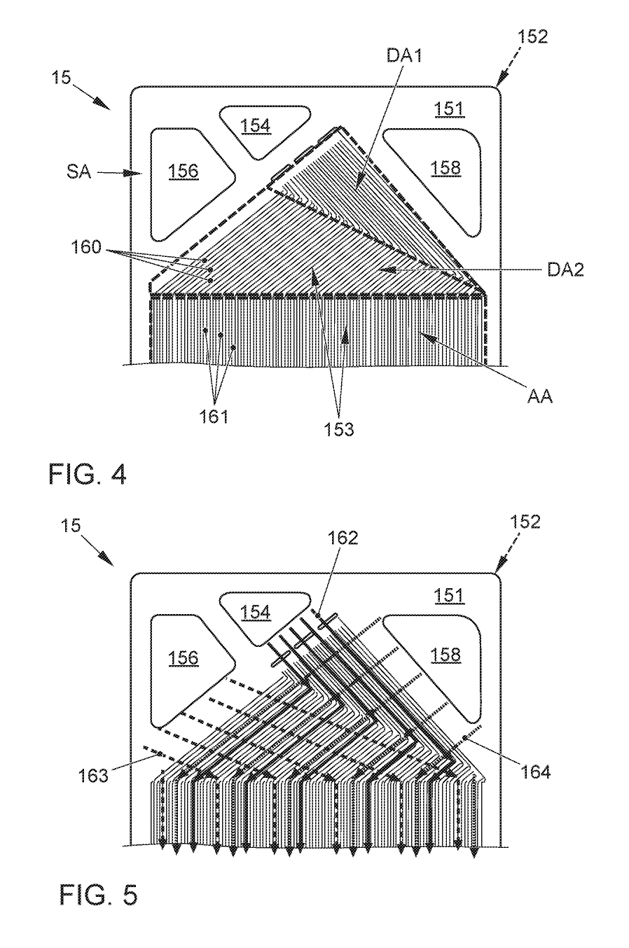

FIGS. 4 and 5 each show a section of bipolar plate 15 according to the present invention of FIG. 3, which shows in particular, feeding inlet ports 154, 156, 158 of supply area SA, distribution area DA, and a portion of active area AA. Again, the view onto anode plate 151 is illustrated. In FIG. 4, the flow patterns of the operating media are indicated, with arrows 162 drawn using continuous lines indicating the anode gas flows, and arrows 163 drawn using dashed lines indicating the cathode gas flows, and arrows 164 drawn using dotted lines indicating the coolant flows.

According to the present invention, anode gas port 154 is situated on one of the short sides of bipolar plate 15 essentially between cathode gas port 156 and coolant port 158. Cathode gas port 156 and coolant port 158 are essentially situated in corner areas of bipolar plate 15.

On anode plate 151, apparent in FIGS. 4 and 5, anode distribution channels 160 are formed in distribution area DA by suitable profiling of anode plate 151. Within distribution area DA, anode gas distribution channels 160 change direction (redirection) (see anode gas flows 162 in FIG. 5). After leaving anode gas inlet port 154, anode gas distribution channels 160 initially run in a straight line across a first section DA1 of distribution area DA toward the longitudinal side of bipolar plate 15 here represented on the right. When passing into a second section DA2 of distribution area DA, anode gas distribution channels 160 change direction, here, for example, by a 90° angle, so that within second section DA2 they run in a straight line toward the opposite side of bipolar plate 15, i.e., here toward the left-hand longitudinal side. When passing into active area AA, anode distribution channels 160 change direction again, to run through active area AA as anode channels 161 of anode flow field 153 in parallel to the longitudinal side of bipolar plate 15. Other embodiments of the anode channels in active area AA, for example, a meandering course, are also possible.

On cathode plate 152, concealed in FIGS. 4 and 5, cathode gas distribution channels are formed in distribution area DA by appropriately profiling cathode plate 152. The cathode gas distribution channels exit from cathode gas inlet port 156 and flow through distribution area DA in a straight line without change of direction. When passing into active area AA, the cathode gas distribution channels become cathode channels of the cathode flow field of active area AA (see cathode gas flows 163 in FIG. 5).

In the same way, the coolant flows from coolant inlet port 158 into the straight-line coolant distribution channels formed between the two plate halves 151 and 152, not visible in the figures, and from there into active area AA (see cathode gas flows 164 in FIG. 5). In first section DA1 of distribution area DA, the internal coolant distribution channels are initially formed on the cathode side by appropriately profiling cathode plate 152. Only the coolant distribution channels and anode gas distribution channels 160 and no cathode distribution channels are situated in first section DA1. In the anode-side illustration of FIGS. 4 and 5, this means that the coolant distribution channels connected to coolant port 158 are situated on the rear side of first section DA1 and initially run underneath anode gas distribution channels 160 in a direction crossing the latter. At the point of passage from first section DA1 to second section DA2, the coolant distribution channels switch from the cathode side to the anode side of bipolar plate 15. In second section DA2, coolant distribution channels 30 thus run in anode plate 151, where they are again designed as channel profiles. In particular, anode gas channels and coolant distribution channels run in parallel to each other in Section DA2 in anode plate 151, the bottoms of anode gas distribution channels 160 forming the side edges of the coolant distribution channels and vice-versa. Coolant distribution channels 30 are thus situated in this second section DA2 in such a way that they run between two anode gas distribution channels 160 essentially on the same level as the latter. In rear cathode plate 152, only cathode distribution channels are formed in second section DA2.

The cathode gas thus flows directly without change of direction within the plane of the plate and without passing from one side to the other from cathode gas port 156 into active area AA. The anode operating medium flows from anode gas port 154 in section DA1 on the anode side undisturbed across the coolant distribution channels running on the cathode side, where it crosses the coolant distribution channels. In second section DA2, the anode gas flows in parallel between the coolant distribution channels in the same plate 151. In this section DA2, the anode gas crosses the cathode distribution channels formed in cathode plate 152. Finally, the coolant flows from coolant port 158 in a straight line without changing direction within the plane of the plate initially in first section DA1 into the inner channel structures of cathode plate 152 and then switches plate levels to be passed to the other side in second section DA2 and to flow in the inner channel structures of anode plate 151 in the same plane as the anode gas.

This configuration of the coolant supply channels allows a least possible disturbance of the anode operating medium and cathode operating medium and thus a reduced pressure drop thereof. The channel design within distribution area DA also allows both sections DA1 and DA2 to have the same overall height, although in second section DA2 three superposed media flows are accommodated in only two half-plates 151, 152. In addition, the two largest volume flows of the cathode gas and the coolant flow within the entire distribution area DA in such a way that they do not interfere with each other.

All in all, the above-described configuration allows the overall height of bipolar plate 15 to be reduced. This configuration allows the total thickness of bipolar plate 15 to be reduced to only 1.0 mm without having to accept a reduction in mechanical stability. Using the present invention, the advantages of carbon materials may thus be utilized, and nevertheless reduced overall heights of bipolar plate 15 and thus of fuel cell stack 10 are enabled.

### LIST OF REFERENCE NUMERALS

100 fuel cell system

10 fuel cell stack

11 single cell

12 anode chamber

13 cathode chamber

14 membrane electrode assembly (MEA)

141 anode side

142 cathode side

143 catalytic electrode/cathode

144 supply port/anode gas port/anode inlet port

145 supply port/anode gas port/anode outlet port

146 supply port/cathode gas port/cathode inlet port

147 supply port/cathode gas port/cathode outlet port

148 supply port/coolant port/coolant inlet port

149 supply port/coolant port/coolant outlet port

15 bipolar plate (separator plate, flow field plate)

151 anode plate

152 cathode plate

153 operating medium flow field/anode gas flow field

154 supply port/anode gas port/anode inlet port

155 supply port/anode gas port/anode outlet port

156 supply port/cathode gas port/cathode inlet port

157 supply port/cathode gas port/cathode outlet port

158 supply port/coolant port/coolant inlet port

159 supply port/coolant port/coolant outlet port

160 anode gas distribution channel (in distribution area DA)

161 anode channel (in active area AA)

162 anode gas flow pattern

163 cathode gas flow pattern

164 coolant flow pattern

20 anode supply

21 anode supply path

22 anode exhaust gas path

23 fuel tank

24 adjusting means

25 fuel recirculation line

26 adjusting means

30 cathode supply

31 cathode supply path

32 cathode exhaust gas path

33 compressor

34 electric motor

35 power electronics

36 turbine

37 wastegate line

38 adjusting means

39 humidifier module

AA active area (reaction area)

SA supply area

DA distribution area

DA1 first section of distribution area DA

DA2 second section of distribution area DA

What is claimed is:

1. A bipolar plate for a fuel cell comprising:
an anode side; and
a cathode side, and, in a top view onto the anode side or cathode side:
operating medium flow fields including an anode gas flow field situated on the anode side, a cathode gas flow field situated on the cathode side, and an internal coolant flow field,
a first supply area and a second supply area situated on diametrically opposite sections of the bipolar plate lateral to the operating medium flow fields;
supply ports situated in the first and second supply areas and designed as through openings, the supply ports including at least one anode gas port for supplying or removing anode gas, at least one cathode gas port for supplying or removing cathode gas, and at least one coolant port for supplying or removing coolant, the at least one anode gas port being situated within the first or second supply areas between the at least one cathode gas port and the at least one coolant port;
the bipolar plate including or being made of a carbon-based electrically conductive material.

2. The bipolar plate as recited in claim 1 wherein the bipolar plate has an overall plate thickness of maximum 1.2 mm.

3. The bipolar plate as recited in claim 2 wherein the bipolar plate has an overall plate thickness of maximum 1.1 mm.

4. The bipolar plate as recited in claim 3 wherein the bipolar plate has an overall plate thickness of maximum 1.0 mm.

5. The bipolar plate as recited in claim 1 wherein the carbon-based electrically conductive material is a graphite material.

6. The bipolar plate as recited in claim 5 wherein the carbon-based electrically conductive material is graphite or a graphite-plastic composite.

7. The bipolar plate as recited in claim 1 wherein the bipolar plate is constructed of two profiled half-plates joined together, the half plates including an anode half-plate and a cathode half-plate, the respective operating medium flow fields being formed in the anode half plate and the cathode half-plate.

8. The bipolar plate as recited in claim 1 wherein the operating medium flow fields have a central active section and two distribution sections adjoining to the central active section on both sides, the two distribution sections being situated between the active section and the supply ports, with anode gas distributor channels, cathode gas distribution channels, and coolant distribution channels running in the two distribution sections.

9. The bipolar plate as recited in claim 8 wherein in a first section of the two distribution sections only the anode gas distribution channels and the coolant distribution channels run, and within the first section the coolant distribution channels are formed by a profile of a cathode half-plate, and the anode gas distribution channels are formed by a profile of an anode half-plate, the anode and cathode half-plates being joined together.

10. The bipolar plate as recited in claim 8 wherein the anode gas distribution channels, the cathode gas distribution channels, and the coolant distribution channels run in a second section of the two distribution sections, and within the second section the coolant distribution channels and the anode gas distribution channels are formed by a channel profile of an anode half-plate, and the cathode gas distribution channels are formed by another channel profile of a cathode plate, the anode and cathode half-plates being joined together.

11. The bipolar plate as recited in claim 10 wherein in the second section, the anode gas distribution channels and the coolant distribution channels run in parallel to each other.

12. The bipolar plate as recited in claim 11 wherein in the second section, the anode gas distribution channels and the coolant distribution channels run in a nested form.

13. The bipolar plate as recited in claim 10 wherein in a first section of the two distribution sections only the anode gas distribution channels and the coolant distribution channels run, and within the first section the coolant distribution channels are formed by the other channel profile of the cathode half-plate, and the anode gas distribution channels are formed by the channel profile of the anode half-plate, the first section and the second section having a same overall height.

14. A fuel cell stack comprising:
membrane electrode assemblies and bipolar plates stacked alternatingly, the bipolar plates including at least one bipolar plate as recited in claim 1.

15. The fuel cell stack as recited in claim 14 further comprising a gas diffusion layer situated between the membrane electrode assemblies and the bipolar plates, the gas diffusion layer extending across an entirety of the anode gas flow field, an entirety of the cathode gas flow field, and an entirety of the coolant flow field.

16. The fuel cell stack as recited in claim 15 wherein the gas diffusion layer extends over the operating media flow fields.
